(19) United States
(12) Patent Application Publication
(10) Pub. No.: US 2005/0166713 A1
(43) Pub. Date: Aug. 4, 2005

(54) Nail holders and methods

(76) Inventor: Rickey G. Lloyd, Lake Point, UT (US)

Correspondence Address: RICKY G. LLOYD;LLOYD LABORATORIES, 2001 E. SHEPHERD LAN, LAKE POINT, UT, 84074, US

(21) Appl. No.: 10/767,629

(22) Filed: Jan. 29, 2004

(51) Int. Cl. B25C 3/00

(52) U.S. Cl. 81/44

(57) ABSTRACT

Nail holders, and related methods, self-biasing one or more nails in a ready-to-be-nailed position adjacent to a workpiece, without using a manually-created clamping force against the nail with the thumb and index finger remote from the nail, are disclosed. Force applied to the nail holder remote from the nail readily separates the nail holder from the nail after the nail is partially driven into a workpiece.

### FIELD OF THE INVENTION

The present invention relates generally to devices for holding nails and, more particularly to self-biasing nail holders, and related methods by which one or more nails are held in a position preparatory by the self bias to being driven by a hammer or the like into a workpiece, without utilization of a manually-generated nail clamping force.

### BACKGROUND

To the exclusion of a nail gun operated by pneumatic or like force, most often one driving a nail holds the nail along its shaft between the thumb and index finger of one hand and drives the nail into a workpiece by striking the head of the nail with a hammer held in the other hand of the user. Frequently, the thumb and/or index finger holding the nail are injured when the hammer accidentally strikes one or both of them.

In isolated or hard to reach places adjacent to the workpiece, it is sometimes difficult to both hold the nail and strike it because of space limitations or awkwardness in the user's position.

To avoid the risk of injury to the thumb and fingers of the user and to better facilitate holding and striking a nail in an isolated or a hard to reach place, the shaft of the nail heretofore has been held by pliers or like manually closed clamping device where manually-created opposite compressive forces are applied to the shaft of the nail, with the nail placed in a position adjacent to the workpiece to be manually driven into the workpiece by a hammer or the like. For the uncoordinated or poorly coordinated, the use of both a manually closed clamping device and a hammer is awkward and sometimes unsuccessful.

It would be of substantial advantage, to have available for use by unskilled persons and professionals as well an easily used, handheld self-biasing nail holder, and related methods, for facilely holding a nail adjacent to a workpiece for nailing without requiring a manually imposed clamping force and which readily accommodates manual separation of the nail holder from the nail after the nail is partially driven in to the workpiece and provides access for high and low locations.

### BRIEF SUMMARY AND OBJECTS OF THE INVENTION

In brief summary, the present invention overcomes or alleviates nail holding and nail driving problems of the past. The risk of injuring one's thumb and fingers is greatly reduced if not eliminated. The present invention obviates the need to apply a manually imposed clamping force with one hand, to hold the nail, in coordination with swinging a hammer or the like with the other hand.

The present invention provides nail holders, and related methods, which self-bias against one or more nails in a ready-to-be-nailed position adjacent to a workpiece, without using a manually-created clamping force. The thumb and index finger are located remote from the nail. Force is applied to the nail holder remote from the nail so that the holder readily separates the nail holder from the nail after the nail is partially driven into the workpiece. Any form of non-manual, self-biasing force may be used, such a magnetic force and memory compressive forces imposed by the nail holder itself.

With the foregoing in mind, it is a primary object to overcome or alleviate nail holding and nail driving problems of the past.

It is another paramount object to provide nail holders, and related methods, which greatly reduce, if not eliminate, the risk of injury to one's thumb and fingers while driving a nail into a workpiece.

It is a further important object to provide self-biasing nail holders, and related methods, which obviates any need for a manually imposed clamping force with one hand while swinging a hammer or the like with the other hand.

It is an additional valuable object to provide novel nail holders, and related methods, by which one or more nails are self-biased by the nail holders in a ready-to-be-nailed position adjacent to a workpiece, without using a manually-created clamping force and with the thumb and index finger of the holding hand placed remote from the nail.

Another significant object is the provision of novel self-biasing nail holders, and related methods, where force is applied by the nail holder against the nail to accommodate setting of a nail into a workpiece with the holder readily being separated from the nail after the nail is partially driven by a withdrawn force applied to a remote handle of the nail holder.

A further object is the provision of nail holders, and related methods, accommodating nail placement in a workpiece in high and/or low locations.

These and other objects and features of the present invention will be apparent from the detailed description taken with reference to accompanying drawings.

### BRIEF DESCRIPTION OF THE DRAWINGS

FIG. 1 is a perspective of one self-biased nail holder exhibiting characteristics of the present invention;

FIG. 2 is an enlarged fragmentary perspective of the distal end of the nail holder of FIG. 1, with a nail releasibly compressively held in an undersized aperture formed collectively between two oppositely biased prongs;

FIG. 3 is an enlarged fragmentary perspective of the distal end of the nail holder similar to FIG. 2, with the nail holder being removed from the nail partially driven into a workpiece;

FIG. 4 is a perspective of another self-biased nail holder, which comprises two rotatable arms pivotally connected at one end.

FIG. 5 is a front elevation of one of the two arms of the nail holder of FIG. 4;

FIG. 5A is an enlarged fragmentary elevation of an embodiment similar to Figure modified to include a notch at the end of a biasing finger or prong;

FIG. 5B is a fragmentary cross section showing a nail holding aperture disposed at an angle;

FIG. 5C is a fragmentary plan view of the distal end of a nail holder comprising a finger with two apertures and a groove associated with a magnet;

FIG. 5D is a perspective view showing one male part of a modified clevis pivot connector which does not require use of a pivot pin;

FIG. 5E is a perspective view showing a second female part of the FIG. 5D connector in a position reversed from its assembled position;

FIG. 6 illustrates one way the nail holder of FIGS. 4 and 5 may be used to drive nails;

FIG. 7 is a fragmentary enlarged perspective of the rotatable or pivotable connection between the two arms of the nail holder of FIGS. 4 and 5;

FIGS. 8 and 9 are front elevations of third and fourth magnetic embodiment of a self-biased nail holder, constructed in accordance with principles of the present invention;

FIG. 10 is a front elevation of another self-biased nail holder, embodying features of the present invention, configured as a pencil; and

FIG. 11 is a front elevation of a further self-biased nail holder embodiment of the present invention, configured as a cartoon character.

### DETAILED DESCRIPTION OF THE ILLUSTRATED EMBODIMENTS

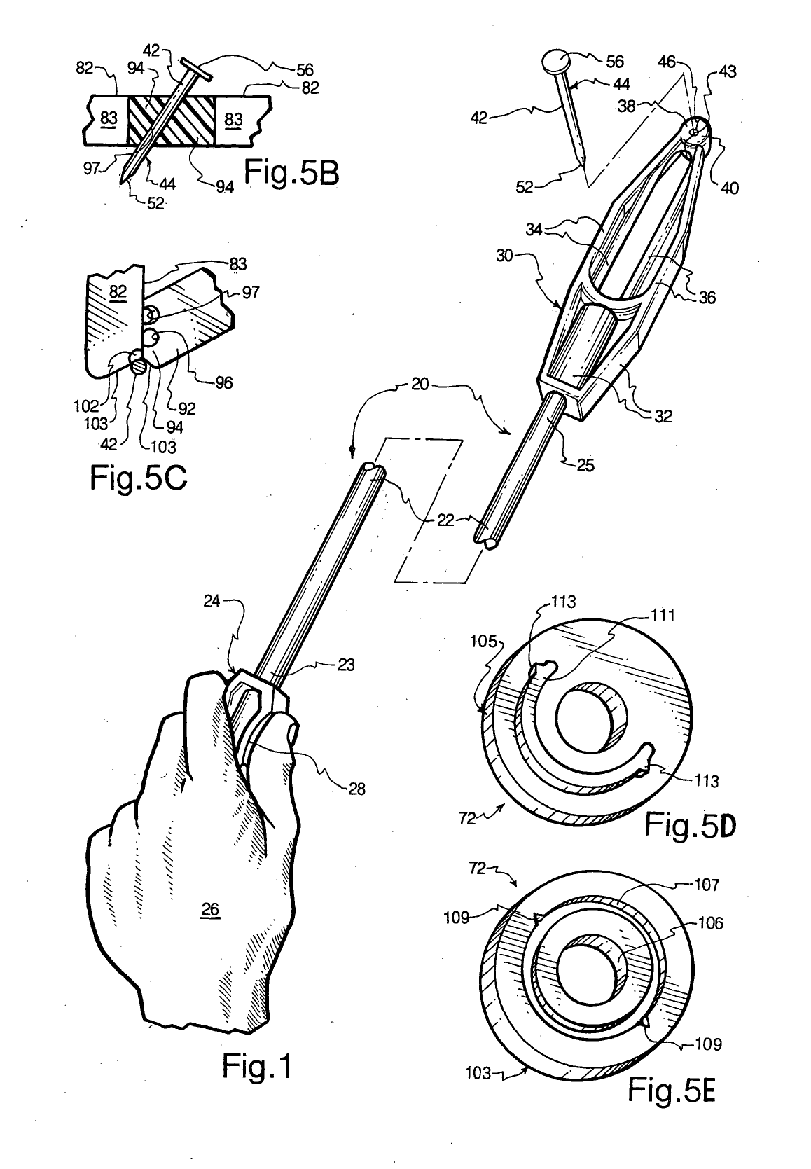

Reference is now made to the drawings wherein like numerals are used throughout to designated like parts throughout. Specifically, FIGS. 1-3 illustrate one nail holder configuration, formed in accordance with the principles of the present invention and generally designated 20. The nail holder 20 comprises a central elongated rod 22 formed of any suitable material, such as wood, synthetic resinous material, graphite, composite, etc. Rod 22 is illustrated as being solid, circular in a cross-sectional configuration and of uniform diameter, although other central portion configurations could be utilized. A handle proximal portion, generally designated 24, is rigidly mounted at the proximal end 23 of the rod 22 in non-rotatable relation. The handle 24 accommodates a tight gripping relation by one hand 26 of the user. While any handle configuration could be utilized, handle 24 is illustrated as comprising undulations 26 to allow the user to obtain and retain a firm grip on the handle 24. Handle 24 may be formed of any suitable material, such as injection molded, rigid synthetic resinous material, formed as a single piece.

A self-biasing clamp, generally designated 30 is located at the distal end of the rod 22. The clamp 30 comprises a base segment 32, rigidly connected to the distal end 25 of the rod 22, in non-rotatable relation. The clamp 30 further comprises a pair of prongs, arms, fingers or jaws 34 and 36 which are formed so that the respective tips 38 and 40 are biased toward each other by reason of the memory of the material from which the clamp 30 is formed, preferably synthetic resinous material with significant memory which does not deteriorate over time. The tips 38 and 40 collectively define the central aperture 43 therebetween. Aperture 43 has a pre-determined dimetral size, which is less than the diameter of the shaft 42 of the nail, generally designated 44. See FIG. 1.

Thus, when the shaft 42 of the nail 44 is inserted through the aperture 43, the dimetral size of the aperture is expanded by separating the surfaces at seam 46. As a consequence, the inherent, internal or self-biasing memory force of the two prongs 34 and 36 cause the tips 38 and 40 to apply equal and opposite compressive forces to the shaft 42 of the nail 44, as shown by arrows 48 and 50 in FIG. 2. The nail is, therefore, compressively, although releasibly held in the position illustrated in FIG. 2, with the pointed tip 52 of the nail 44 (FIG. 1) disposed adjacent to and preferably contiguous with a workpiece 54 into which the nail is to be driven using a hammer or the like (by successively striking the head 56 of the nail).

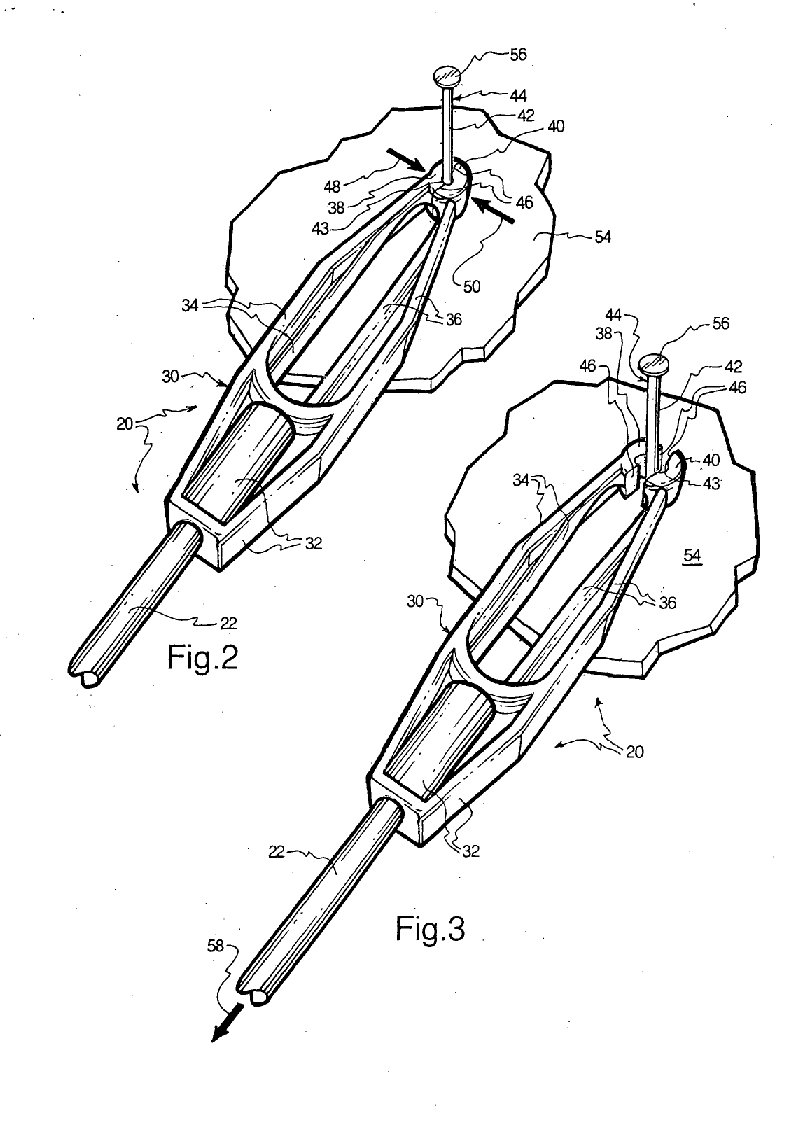

Once the nail has sufficiently penetrated, and is set into the workpiece 54, the user at hand 26 applies an axial force (diagrammatically illustrated at arrow 58 in FIG. 3) through the handle 24 and along the rod 22, causing the opposed surfaces defining seam 46 to ride over the shaft of the nail counter to the forces 48 and 50 (FIG. 2), thereby removing the self-biasing clamp 30 from the nail. Thereafter, the striking instrument (hammer or the like) is used again to strike head 56 of the nail 44 until it is disposed at the desired depth in the workpiece 54.

The nail holder 20 may be utilized in the manner explained above to successively place as many nails as desired. The nail holder 20 is of particular advantage when the nail 44 is being placed in a hard-to-reach position. It also obviates a need to hold the nail 44 between the thumb and index finger while the nail had 56 as being struck by hammer or the like, thereby eliminating the risk of injury due to any mis-hit of the nail.

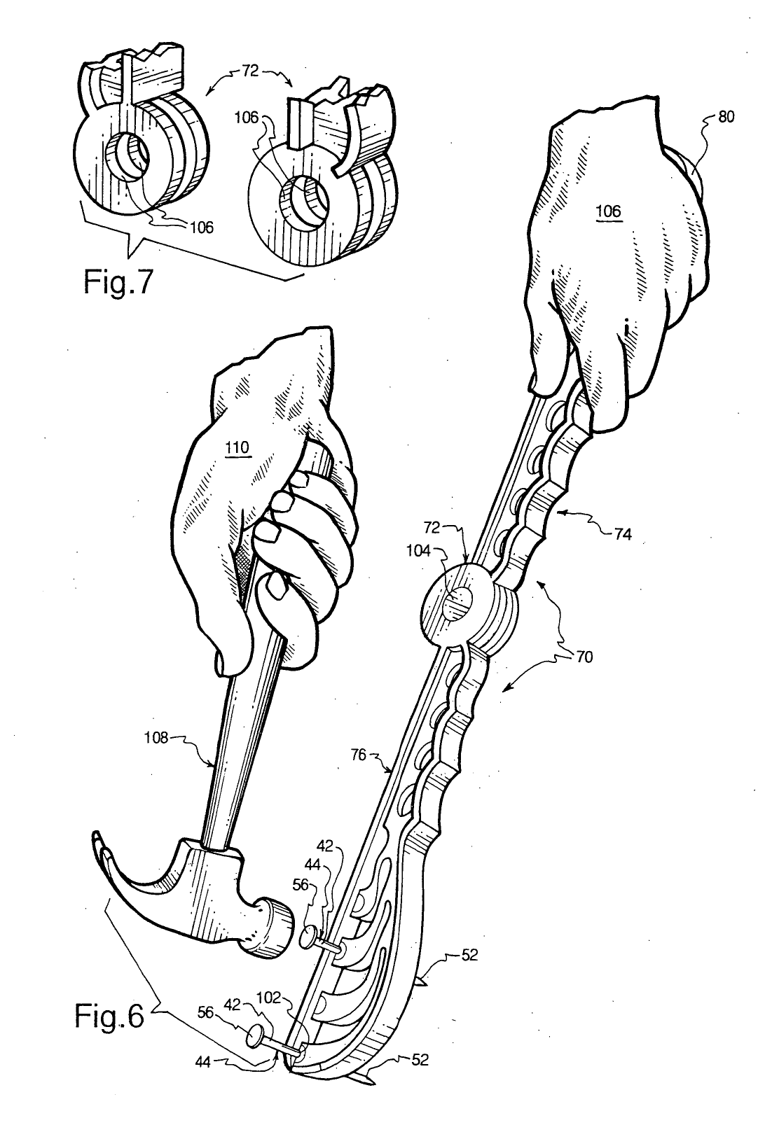

Reference is now made to FIGS. 4-7, which illustrate a second expandable nail holding device, generally designated 70. The device 70, as shown in FIG. 4, comprises a central clevis portion, generally designated 72, accommodating rotation of two substantially identical though opposite hand halves from the contiguous position of FIG. 4 to the extended position of FIG. 6. However, while the nail holder 70 may be used in the extended or expanded position illustrated in FIG. 6. It may also be used in the folded or collapsed position of FIG. 4 or the expanded position of FIG. 6 to assist in driving one or more nails partway into a workpiece, in the manner explained above.

The nail holder 70, as mentioned above, comprises two substantially identical though opposite hand parts, generally designated 74 and 76, rotatably secured one to the other at central rotatable connector 72. When in the position illustrated in FIG. 4, the undulations 78 on both sides collectively comprise a proximal handle proportion while the enlarged collective teardrop portion 80 comprise the distal portion of the nail holder 70, at which location one or more nails are compressively temporarily held by the memory of material from which parts 74 and 76 are made, in a manner hereinafter explained in grater detail.

The collective handle portion of the two parts 74 and 76 comprising undulation 78 is illustrated as being constructed so as to have recesses and apertures along a web to reduce the overall weight of the nail holding device 70 while providing sufficient strength. Parts 74 and 76 may be formed of any suitable material such as wood, metal, synthetic resinous material, composite material, or graphite or the like. Each may be formed as a single piece.

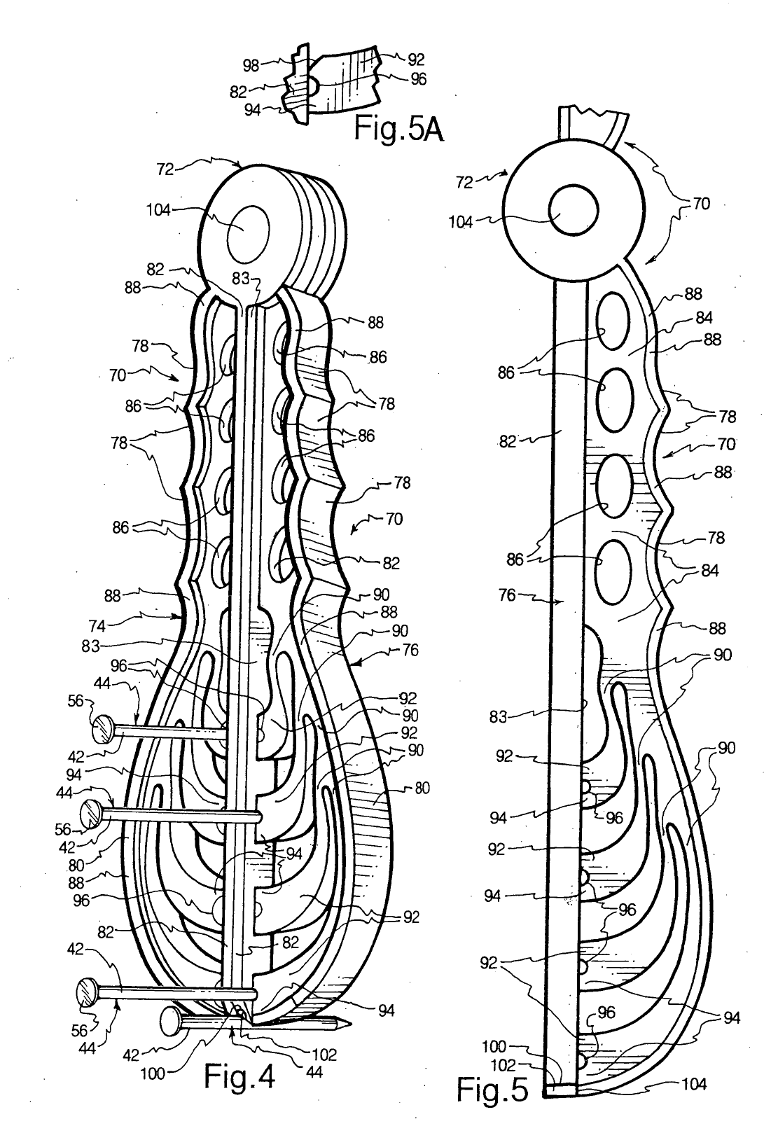

Since the two substantially identical though opposite hand parts 74 and 76 of the nail holder 70 comprise essentially identical components, only one need be described. Accordingly, reference is now made to FIG. 5, which predominantly illustrates one half part 76 of the nail holder 70.

Half segment 76 comprises an axially directed rigid flange 82, illustrated as having a rectangular cross section, although other configurations could be utilized. Half segment 76 further comprises a thin web 84, which is essentially planar, with the plane being disposed essentially perpendicular to a plane containing flange 82. To reduce weight and yet provide ample strength, the web 84 defines a plurality of aperture 86. A second circuitous flange 88 is contiguous with the web 84 and disposed opposite to and away from the flange 82. Flange 88 provides strength as well as defining, at undulations 78, a handle of predetermined shape for manually gripping the nail holder 70.

Extending from the web 84, at sites 90, are a plurality of curved fingers or prongs 92. Fingers 92 are respectively cantilevered in the fashion shown in FIG. 5, each having a distal end 94, which is unconnected but, in the absence of a nail, contiguous with an adjacent surface 83 the flange 82, being so biased by the memory of the material from which fingers 92 are prongs 92 is constructed.

The distal ends 94 of each prong or finger 92 defines a nail-receiving aperture 96, shown as being semi-circular, although other aperture configurations could be used. The selected size of the apertures 96 disposed at the distal end 94 of the fingers or prongs 92 is undersized, namely of smaller opening than the diameter of nail 44 inserted therein, as shown best in FIGS. 4 and 6. In doing so, the distal end 94 will become slightly spaced from the adjacent surface 83 of flange 82, with the nail being in contact with surface 83. If desired, the distal end 94 of any prong 92 may be notched as shown at surface 98 in FIG. 5A, to accommodate ease of insertion and/or removal of the nail 44 into and from the associated aperture 96.

With reference to FIG. 5B, which is similar to FIG. 5A, the aperture 97 may be disposed at an angle sloped toward the distal end of the nail holder to accommodate toe nailing. The angle may be 45° or any other desired angle.

At its distal end, the flange 82 is notched at site 100, where a small permanent magnet 102 is attached or embedded, in any suitable way, such as by using an appropriate bonding agent. Thus, when a nail 44 is place contiguous with permanent magnet 102, as illustrated in FIG. 4, the nail will be temporarily held by magnetic force in the illustrated position preparatory to being driven by a hammer or the like into a workpiece.

With reference to FIG. 5C, the permanent magnet 102 may be disposed juxtaposed a groove 103 to secure and provide alignment to a nail inserted into the groove 103. The groove 103 may be V-shape or any other suitable configuration. FIG. 5C also illustrates placement of two undersized apertures 96 and 97 between the distal end 94 of prong 92 and abuttment 82. While one perpendicular aperture 96 and one angular or distally sloped aperture 97 are shown, any form, configuration and alignment of two or more apertures may be utilized with a single prong.

With reference to FIG. 7, the rotatable connector 72 is in the nature of a simple clevis, accommodating insertion of a pivot pin 104 (FIG. 6) snugly through the aligned apertures 106 to accommodate rotation of one half 74 relative to the other half 76 between the position of FIG. 4 and the position of FIG. 6.

In some connector configurations, the pivot pin may be eliminated, as shown in FIGS. 5D and 5E. More specifically, connector 72 has no pivot pin in any of the apertures 106. Clevis part 103 comprises a curvilinear slot 107 traversing 300°, as illustrated, with two female detent elements 109 located 180° apart. A second part 105 comprises a curvilinear rib 111 traversing 180° sized to fit into the slot 107 in an assembled condition. The rib 113 comprises a male detent element 113 sized and shaped to contiguously engage either female detent element 109 to retain the pivoted arms either in side-by-side relation or in the 180° extended position. Female detent elements may be added along the groove 107 for engagement by the male detent 113 of the rib 111 to provide for retention in less than 180° of rotation. The retention strength of the detent elements may be manually overcome when adjustment of the relative rotational positions of the arms 74 and 76 is desired. The ring 111 and the slot 107 allow relative rotation, but are snugly contiguous to prevent inadvertent separation of parts 105 and 103.

It is to be appreciated that any suitable type of rotatable connection may be used between rotatable arms of nail holders according to the present invention.

It is to be appreciated that the nail holder 70, described above, may be positioned as illustrated in FIG. 4 with the user gripping the undulations 78 in one hand so as to hold the nail holder 70 adjacent to a workpiece, while driving into the workpiece the one or more nails releasibly secured in apertures 96. Thereafter, by axially pulling on the nail holder 70 with the hand gripping the undulations 78 so as to separate the partially driven nail or nails from the associated aperture 96 and finger 92. To this end, it should be appreciated that flange 88, at its lower end, as illustrated in FIG. 5, does not connect at interface 104 to flange 82. Similarly, when a nail 44 is held by magnet 102, after being partially driven into a workpiece, separation of the nail from the magnet is accommodated by the above-described axial pulling force applied by the gripping hand of the user.

In addition to utilizing the nail holder 70 in the collapsed configuration shown in FIG. 4, the two halves 74 and 76 may be relatively rotated into an expanded or expanded position about rotatable connector 72 so that one part 74 extends away from the other part 76, either in alignment therewith or at an angle to part 76. In this configuration, location 80 of part 74 is grasped in one hand 106 of the user, thus becoming the proximal end of the nail holder 70, while one or more nails are held in apertures 96 and/or by magnet 102 at the distal end of part 76. This is illustrated in FIG. 6, as is a hammer 108 held in the other hand 110 of the user preparatory to striking each nail 44 temporarily held by nail holder 70.

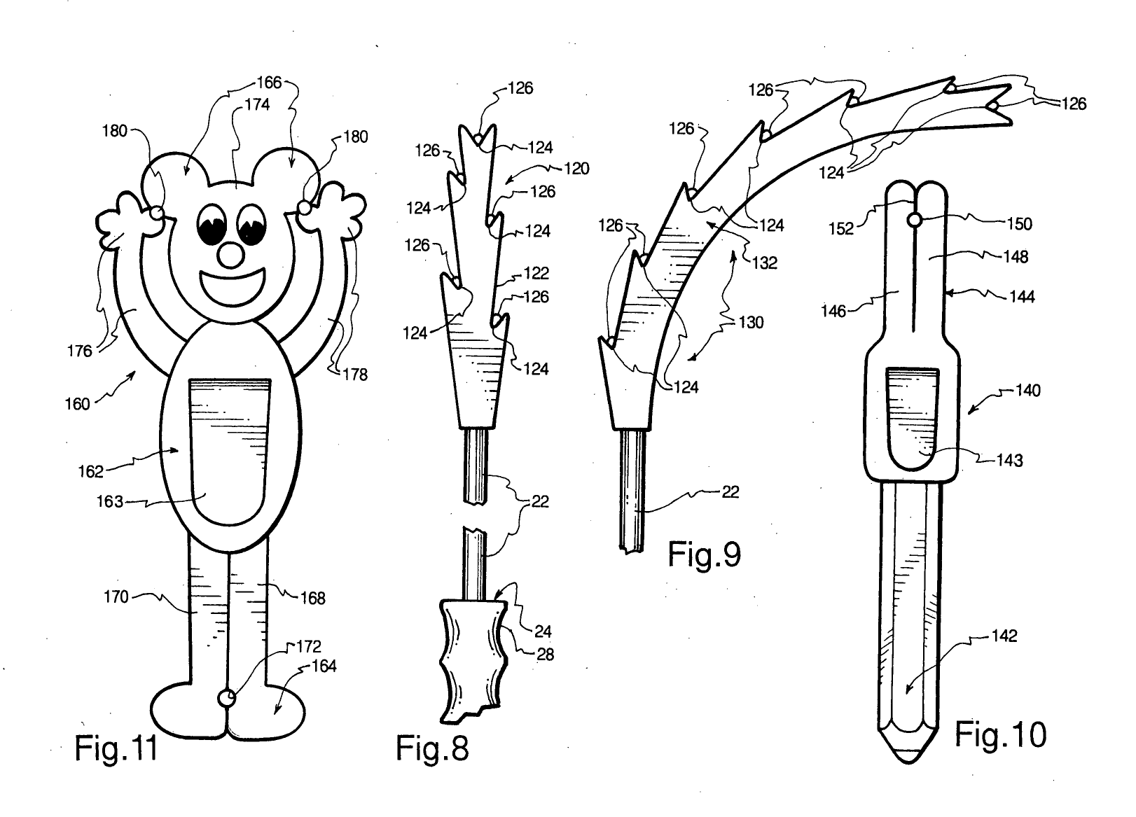

An almost endless number of configurations of nail holders embodying principles in accordance with the present invention fall within the scope of this invention. For example, see FIG. 8, which illustrates a linearly-disposed nail holder, generally designated 120, comprised of proximal handle 24, central rod at 20 and a distal self-biasing head 122 comprised of a plurality of spaced notches 124 in which a permanent magnet 126 is secured or embedded. Nails are temporarily held by magnetic bias, preferably in a V slot to provide alignment and better secure the nail preparatory to being driven into a workpiece, as explained above.

Similarly, non-linear configurations may be utilized, such as nail holder 130, shown in FIG. 9. Nail holder 130 is comprised of a proximal handle (not shown), a central rod 22 and a non-rotatable distal head, generally designated 132, preferably made of a suitable elastomeric material for easy loading of nails with one hand from a supply of nails. The distal head 132 is comprised of notches 124, each of which carries a permanent magnet 126. Nails are temporarily held by the magnetic force of the magnets 126 accommodating driving of the nails into a workpiece. The curvilinear configuration of nail holder 130, shown in FIG. 9, is that it may be used to locate nails in remote or hard to access locations somewhat better, in certain circumstances, than linear configurations, and in picking up nails from a pile of other source of nails.

In addition, the present invention lends itself well to decorative configurations, two examples of which are shown in FIGS. 10 and 11. FIG. 10 illustrates nail holder 140 held in a pencil by a friction fit and may comprise structure accommodating use as a writing instrument. The nail holder 140 comprises a proximal end 142, adapted to be grasped in one hand of the user and a proximal end, generally designated 144, comprised of two prongs 146 and 148, which are contiguously yieldable and between which an aperture 150 is collectively formed. The at rest diameter of the aperture 150 is preferably adapted to be slightly less than the diameter of nail 44 to accommodate force-fit insertion of the shaft of the nail into the aperture 150, insuring that the nail will not inadvertently be displaced from aperture 50. The memory from which the material comprising prongs or fingers 146 and 148 imposes opposite compressive forces upon the nail holding it in position until the nail is set (partially driven) into the workpiece, at which time an axial force applied at the proximal end 142 of the nail holder 140 away from the aperture 150 accommodates separation of the nail holder 140 from the nail along a path defined by interface 152 between the two prongs. The nail holder 140 is illustrated as comprising a clip 143 by which the nail holder 140 may be securely stored in a pocket of the user.

FIG. 11 illustrates the decorative, reversible nail holder, generally designated 160, having a central portion, generally designated 162, in the shape of a cartoon character. Holder 160 further defines a first end, generally designated 164, and a second end, generally designated 166. End 164 is comprised of two prongs 168 and 170, which collectively define an undersized aperture 172 therebetween. The prongs 168 and 170 are configured to generally resemble legs and feet. In lieu of the character shown in FIG. 11, any shape be used including, but not limited to, human images, animal images and/or various inanimate objects.

The end 166 comprises a head 174 of the cartoon character, as well as two arms and hands 176 and 178. Between each hand and the ears of the head is defined an undersized aperture 180. The legs 168 and 170 as well as the hands and arms 176 and 178 are formed of a material having memory so that when a nail is placed in any of the apertures 172 and 180, the diameter of the nail is larger than the diameter of the aperture causing the memory of the material from which the nail holder 160 is made to exert a memory bias upon the nail, holding the nail in position accommodating hammering thereof partway into the workpiece. By pulling on the device 160 in the appropriate direction, the two adjacent parts defining each aperture 172 and 180 accommodates removal of the nail holder 160 from the nail, in the manner explained above. It should be evident from inspection of FIG. 11, that either end 164 and 166 may be gripped by the user so as to become the proximal end, while the other end becomes the distal end where at least one nail is held preparatory to being driven into a workpiece. The nail holder 160 is illustrated as comprising a clip 163 by which the nail holder 160 may be securely stored in a pocket of the user.

The invention may be embodied in other specific forms without departing from the spirit of the central characteristics thereof. The present embodiments therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A self-biasing nail holder comprising:
a proximal handle;
a distal nail-holding segment which applies a self-bias by which a nail is temporarily held in a ready-to-be-nailed position, without application of a manually-created clamping force;
a central portion spanning between the proximal handle and the distal nail holding segment.

2. A self-biasing nail holder according to claim 1 wherein the proximal handle comprises an easily gripped segment.

3. A self-biasing nail holder according to claim 1 wherein the central portion comprises a rigid segment.

4. A self-biasing nail holder according to claim 1 wherein the central portion comprises a slender elongated portion.

5. A self-biasing nail holder according to claim 1 wherein the nail holder comprises, a connector by which a first portion and a second portion can be relatively rotated.

6. A self-biasing nail holder according to claim 1 wherein the central portion comprises a configuration replicating a known symbol.

7. A self-biasing nail holder according to claim 1 wherein the distal nail holding segment comprises at least one undersized aperture, the size of which is enlarge upon insertion of a nail therein counter to the bias.

8. A self-biasing nail holder according to claim 7 wherein the at least one undersized aperture is selected from the group consisting of apertures perpendicular to a plane containing the nail holder and apertures angularly disposed to said plane.

9. A self-biasing nail holder according to claim 7 wherein the at least one aperture comprises at least two apertures.

10. A self-biasing nail holder according to claim 1 wherein the two distal nail-holding segment comprises at least one nail holding magnet.

11. A self-biasing nail holder according to claim 10 wherein the magnet is adjacent to a nail receiving groove in the nail holder.

12. A self-biasing nail holder according to claim 1 wherein the distal nail-holding segment which applies the force is selected from the group consisting of: (a) at least one nail constraining magnet, (b) at least one resiliently self-biased prong defining at least in part one undersized aperture into which a nail is constrainingly place preparatory to being nailed into a workpiece and (c) at least two resiliently self-biased prongs collectively defining at least one undersized aperture into which a nail is constrainingly placed preparatory to being nailed into a workpiece.

13. A method of temporarily holding at least one nail in a position accommodating driving the nail into a workpiece comprising the acts of:
(a) causing the nail to be forcibly held in said position by a bias imposed by a nail holder itself, without imposing a manual force to the nail;
(b) manually grasping the nail holder at a site remote from the position of the nail;
(c) position the nail holder so that a distal tip of the nail is juxtaposed to the workpiece;
(d) driving the nail partially into the workpiece by striking a proximal head of the nail;
(e) imposing a force on the nail holder remote from the nail causing separation of the nail holder from the partially driven nail.

14. A method of temporarily holding at least one nail in a position accommodating driving the nail into a workpiece comprising the acts of:
(a) causing the nail to be forcibly held in said position by magnetic force imposed at a nail holder itself, without imposing a manual force to the nail;
(b) manually grasping the nail holder at a site remote from the position of the nail;
(c) position the nail holder so that a distal tip of the nail is juxtaposed to the workpiece;
(d) driving the nail partially into the workpiece by striking a proximal head of the nail;
(e) imposing a force on the nail holder remote from the nail causing separation of the nail holder from the partially driven nail.

15. A method of temporarily holding at least one nail in a position accommodating driving the nail into a workpiece comprising the acts of:
(a) causing the nail to be forcibly held in said position by compression force imposed by a nail holder itself, without imposing a manual force to the nail;
(b) manually grasping the nail holder at a site remote from the position of the nail;
(c) position the nail holder so that a distal tip of the nail is juxtaposed to the workpiece;
(d) driving the nail partially into the workpiece by striking a proximal head of the nail;
(e) imposing a force on the nail holder remote from the nail causing separation of the nail holder from the partially driven nail.
